(19) United States
(12) Patent Application Publication
(10) Pub. No.: US 2026/0295311 A1
(43) Pub. Date: Oct. 1, 2026

(54) MASK WITH TRANSLUCENT FLAP

(71) Applicant: MAKRITE INDUSTRIES INC., New Taipei City (TW)

(72) Inventor: Cheryl CHO, New Taipei City (TW)

(73) Assignee: MAKRITE INDUSTRIES INC., New Taipei City (TW)

(21) Appl. No.: 19/234,057

(22) Filed: Jun. 10, 2025

(30) Foreign Application Priority Data
Mar. 28, 2025 (CN) 202510383127.4

(51) Int. Cl. A62B 23/02; A62B 18/10

(52) U.S. Cl. CPC A62B 23/025; A62B 18/10

(57) ABSTRACT

A mask of the present invention includes: a mask body, an elastic band and an air valve. The air valve includes a valve seat, a valve cover and a translucent flap, and a fixing portion of the valve seat and a pressing member of the valve cover clamp the translucent flap together, and the translucent flap includes a first thermoplastic plastic layer and a second thermoplastic plastic layer in contact with the valve seat. The first thermoplastic plastic layer is PET, and the second thermoplastic plastic layer is TPU, wherein surface roughness and elasticity of the second thermoplastic plastic layer are higher than that of the first thermoplastic plastic layer. Therefore, a user can conveniently confirm an internal state of the mask and the air-tightness of the air valve through two characteristics, such as transparency and color of the translucent flap.

### FIELD OF THE INVENTION

The present invention relates to a mask with an air valve, and in particular to a three-dimensional mask with a translucent flap constituted by employing a double-layer material in the air valve.

### BACKGROUND OF THE INVENTION

Common masks on the market are a type of respiratory protective instruments used for filtering out harmful substances in the air to protect the personal respiratory system. However, the main reason why most users do not like to wear masks is mostly that the hot and humid gas is not easy to be discharged from the mask or discomfort caused by the too large airflow impedance. Therefore, in order to alleviate occurrence of the foregoing situations, exhalation valves that can exhaust a large amount of air quickly are widely applied in the field of masks.

A conventional air valve type mask includes a mask body, an exhalation valve and a rope belt. The exhalation valve includes a base having a window, an upper cover combined with the base and an elastic film openably covering the window. When a user wears the air valve type mask, the air valve type mask can fit the face to cover the mouth and nose by hanging the rope belt on the ear or the back of the head. When the user inhales, a negative pressure state is formed inside the mask body, allowing external air to enter the inside through a filtering material of the mask body, thereby filtering the external air and keeping the flap of the air valve in a closed state. Additionally, when the user exhales, a positive pressure state is formed inside the mask body, so that the flap of the air valve is pushed open by the exhaled gas, allowing the gas to be quickly discharged from the inside of the mask body.

### SUMMARY OF THE INVENTION

A primary objective of the present invention is to provide a three-dimensional mask with a translucent flap designed in an air valve, so that a user can observe an internal state of the mask through the transparent characteristics of the flap, and the user also can conveniently identify whether the flap itself has micro-deformation through the color characteristics of the flap, and can confirm whether there is any non-tightness between the flap and the valve seat.

A secondary objective of the present invention is to employ different thermoplastic plastic layers to make a translucent flap, so that the slapping sound of the translucent flap under a breathing state of the user is reduced, and there is a better fit between the flap and the valve seat, so that the sealing effect of the air valve is better.

Another objective of the present invention is to change a pressing position and lateral width of the valve cover on the translucent flap, so that a return speed at which the translucent flap contacts the valve seat can be increased while the fit between the flap and the valve seat is maintained.

In order to achieve the aforementioned objectives, the mask with a translucent flap of the present invention includes a mask body, an elastic band and an air valve. The mask body is used for covering a mouth and a nose of a user, and the mask body has an opening portion; the elastic band is connected to the mask body; and the air valve is connected to the opening portion, so that the opening portion forms a closed state.

The air valve includes: a valve seat, a translucent flap and a valve cover. The valve seat has a surrounding wall portion forming a target profile, an inner window portion, and a fixing portion. The inner window portion and the fixing portion are connected at an inner side of the surrounding wall portion. The translucent flap is assembled on the fixing portion to cover the inner window portion, and the translucent flap has a target shape matching the target profile. The valve cover is detachably connected to the valve seat, and an accommodating space is formed between the valve seat and the valve cover. The valve cover has a shielding portion for overlapping an upper half region of the inner window portion and an outer window portion for overlapping a lower half region of the inner window portion, and the shielding portion extends a pressing member towards the translucent flap, wherein a pressed end of the translucent flap being clamped by the pressing member and the fixing portion, and a free end of the translucent flap is capable of being pushed by a breathing airflow to change the closed state of the opening portion to an open state.

The translucent flap of the present invention includes a first thermoplastic plastic layer and a second thermoplastic plastic layer in contact with the inner window portion. The first thermoplastic plastic layer has a first surface roughness and a first elasticity, and the second thermoplastic plastic layer has a second surface roughness greater than the first surface roughness and a second elasticity greater than the first elasticity. The first thermoplastic plastic is a transparent sheet made of polyethylene terephthalate, the second thermoplastic plastic is a translucent sheet made of thermoplastic polyurethane, and the dimensions of the transparent sheet and the translucent sheet are respectively between 0.01 millimeters to 0.1 millimeters.

In a preferred embodiment, the fixing portion of the valve seat extends towards the valve cover to form an inserting plate, and the pressing member of the valve cover includes a sleeve that matches the inserting plate, a lateral piece spaced apart from the sleeve, and a plurality of reinforcing ribs connected between the sleeve and the lateral piece. The width of the lateral piece is greater than that of the sleeve, and the position of the lateral piece overlaps the inner window portion.

The inner window portion is formed with a descent region and an ascent region in sequence from the pressed end towards the free end, so that the inner window portion is configured to an arc-shaped structure; and the sleeve, the reinforcing ribs and the lateral piece are matched with the descent region to present an arc-shaped pressing surface. Moreover, a raised wall is formed on the peripheries of both the descent region and the ascent region, and a surrounding groove is formed between the inner window portion and the surrounding wall portion, so that the inner window portion is entirely located outside an opening cross section of the opening portion.

The translucent flap has a gradually expanding profile and a gradually narrowing profile in sequence from the pressed end towards the free end, so that the target shape of the translucent flap and the target profile of the valve seat are configured to a shell shape; and the first thermoplastic plastic layer has a transparent and colored smooth surface, and the second thermoplastic plastic layer has a translucent and colored matte surface.

The present invention is characterized in that the translucent flap is formed by combining thermoplastic plastic sheets with different surface roughness and elasticity, where the second thermoplastic plastic layer with higher surface roughness and elasticity can contact the valve seat to generate better adhesion, thereby improving the tightness between the valve seat and the translucent flap.

### BRIEF DESCRIPTION OF THE DRAWINGS

FIG. 1 is a front view of a mask of the present invention;

FIG. 2 is a rear view of the mask of the present invention;

FIG. 3 is an exploded view of an air valve;

FIG. 4 is a front view of the air valve in an exploded state;

FIG. 5 is a cross-sectional view of the air valve in the exploded state;

FIG. 6 is a schematic cross-sectional view of a translucent flap;

FIG. 7A is a front view of the translucent flap;

FIG. 7B is a rear view of the translucent flap;

FIG. 8A is a schematic diagram showing that a user exhales to open the translucent flap; and

FIG. 8B is a schematic diagram showing that the user inhales to close the translucent valve.

### DETAILED DESCRIPTION OF THE PREFERRED EMBODIMENTS

In order to further understand the construction, use and characteristics of the present invention definitely, fully and accurately, preferred embodiments are given, which are described in detail hereafter in connection with the accompanying drawings.

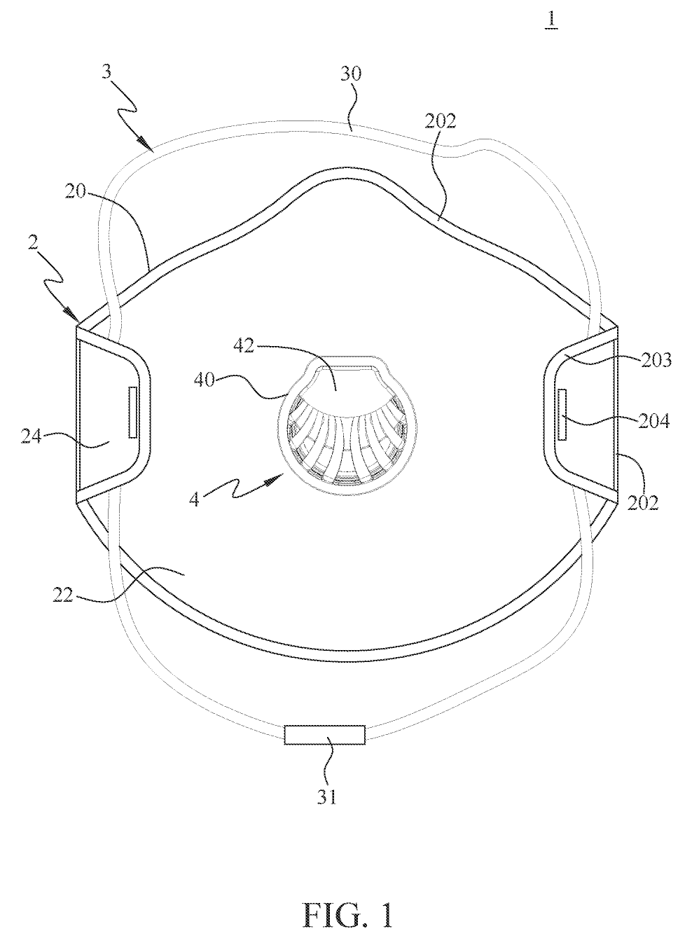

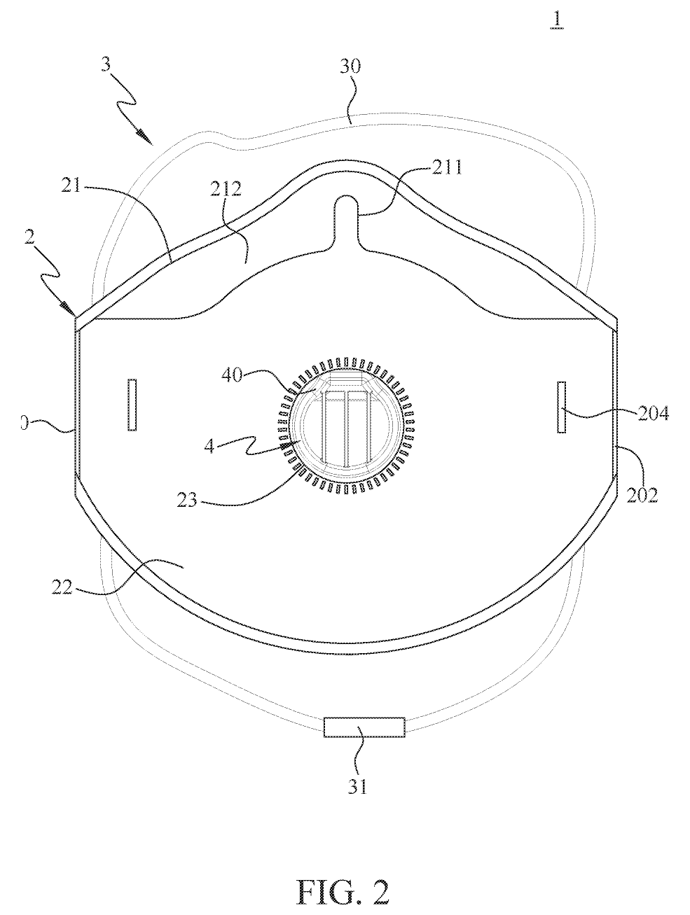

Referring to FIGS. 1 and 2, the mask 1 with a translucent flap of the present invention includes a mask body 2, an elastic band 3 and an air valve 4. The mask body 2 includes a three-dimensional filtering material 20 and a nose cushion material 21 located at the rear side of the three-dimensional filtering material 20. The three-dimensional filter material 20 has a mask portion 22 molded into a bowl shape, an opening portion 23 located in the center of the mask portion 22, and two connecting portions 24 located at two opposite sides of the mask portion 22. The mask portion 22 is used for masking a mouth and a nose of a user. The two connecting portions 24 are counter-folded from an edge of the mask portion 22 to a front side of the mask portion 22, so that a rope threading channel is formed between the connecting portion 24 and the mask portion 22.

As shown in FIG. 1, the three-dimensional filtering material 20 includes two counter-folded lines 201, a first peripheral line 202, a second peripheral line 203, and two connecting lines 204, where the two counter-folded lines 201 are respectively formed at an adjacent side between the mask portion 22 and the connecting portion 24, the first peripheral line 202 is formed at an upper edge and a lower edge of the mask portion 22, the second peripheral line 203 is formed at an outer edge of the connecting portion 24, and the two connecting lines 204 are formed at a contact point between the connecting portion 24 and the mask portion 22; and as shown in FIG. 2, the nose cushion material 21 is hot pressed on the first peripheral line 202, and the nose cushion material 21 has a notch portion 211 located in a center position and two contact sheets 212 located on two opposite sides of the notch portion 211.

Referring to FIG. 1 again, the elastic band 3 includes a band body 30 and a band buckle 31, where two ends of the band body 30 are respectively inserted into different rope threading channels on both sides of the mask portion 22 from top to bottom, and two ends of the elastic band 3 are combined with the band buckle 31 below the mask portion 22, so that the elastic band 3 cooperates with the mask body 2 to form an upper supporting loop and a lower supporting loop, whereby the user can stretch the upper supporting loop and the lower supporting loop open with both hands, so that the head of the user can enter the upper supporting loop and the lower supporting loop for stable wearing.

However, the structural description of the elastic band 3 and the connecting portion 24 is only for the convenience of example, and is not intended to be limiting. That is, the mask 1 of the present invention may also use two elastic bands 3 to fix one of the two connecting portions 24 respectively, so that the user can wear the two elastic bands 3 to the ears.

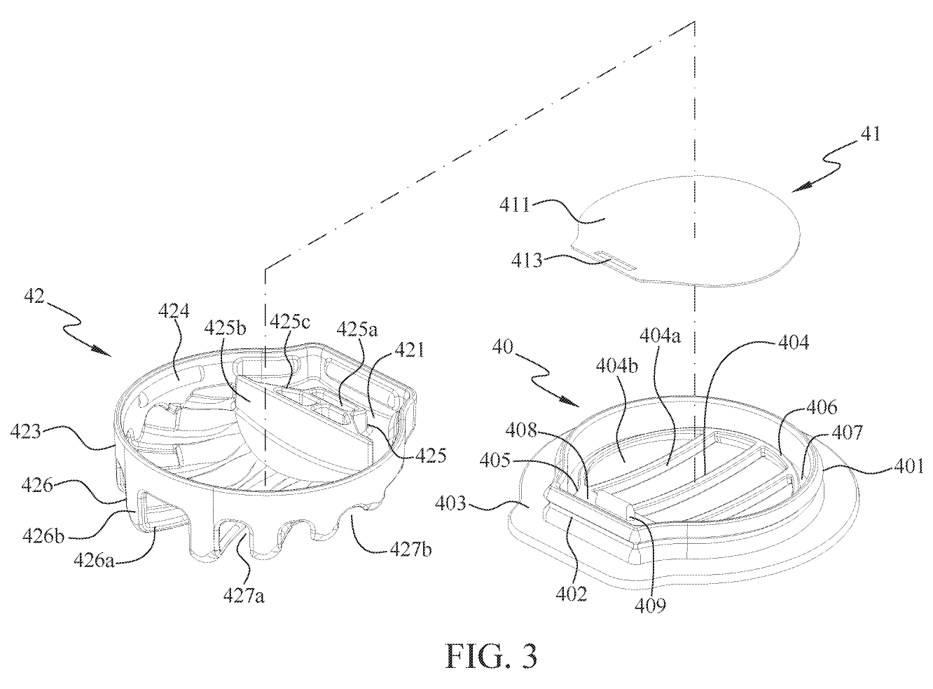

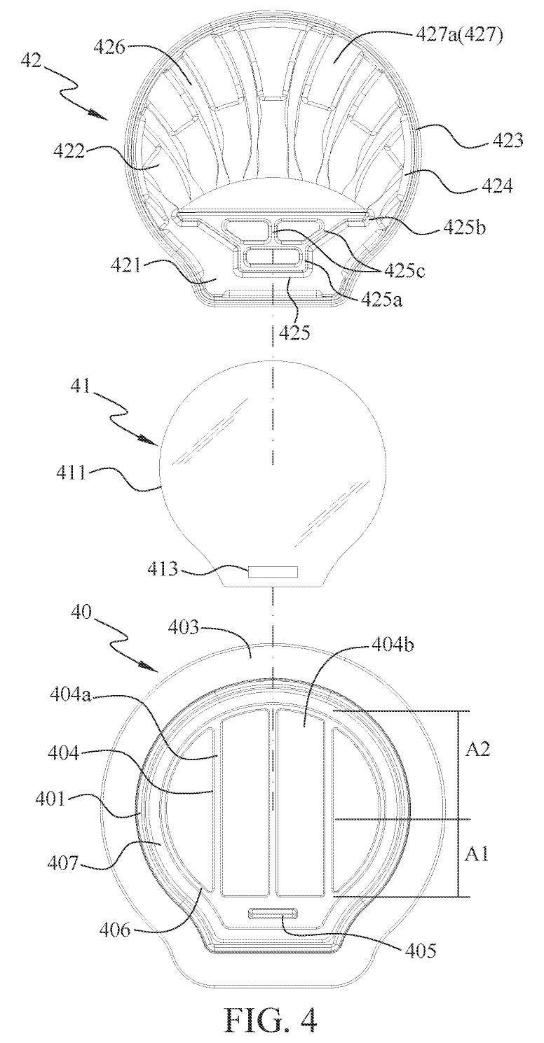

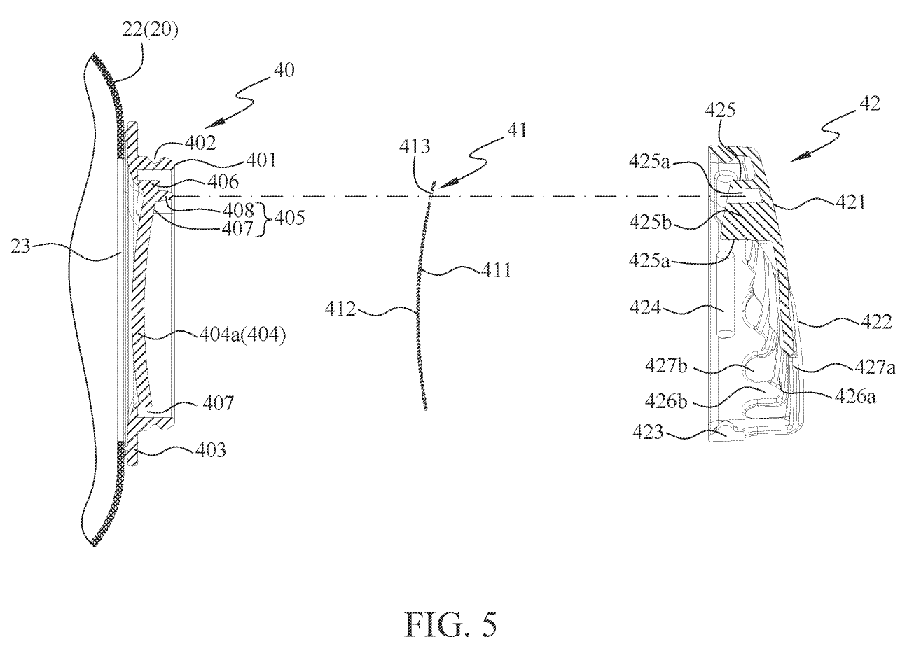

Moreover, the air valve 4 is fixed to the opening portion 23 by hot pressing, so that the opening portion 23 forms a closed state. Referring to FIGS. 3 to 5, the air valve 4 includes: a valve seat 40, a translucent flap 41 and a valve cover 42, where the valve seat 40 has a surrounding wall portion 401 forming a target profile, the surrounding wall portion 401 has an inner concave annular groove 402, and an annular convex portion 403 extending outward to connect the opening portion 23, and an inner window portion 404 and a fixing portion 405 are formed on an inner side of the surrounding wall portion 401. The inner window portion 404 has a plurality of ribs 404a and a plurality of windows 404b arranged alternately, and the plurality of ribs 404a and the plurality of windows 404b present an arc-shaped pattern, so that the inner window portion 404 is formed with a descent region A1 and a ascent region A2, and meanwhile a raised wall 406 is formed on the peripheries of both the descent region A1 and the ascent region A2, and a surrounding groove 407 will be formed between the inner window portion 404 and the surrounding wall portion 401, so that the inner window portion 404 is entirely located outside an opening section of the opening portion 23; and the fixing portion 405 has a baffle 408 located above the inner window portion 404, and the baffle 408 extends outwardly to form a inserting plate 409.

The translucent flap 41 is installed on the fixing portion 405 to contact and close the inner window portion 404, and has a target shape that matches the target profile; and in a feasible embodiment of the figures, the translucent flap 41 has a gradually expanding profile C1 and a gradually narrowing profile C2, so that the target shape of the translucent flap 41 matches the target profile to present a shell shape.

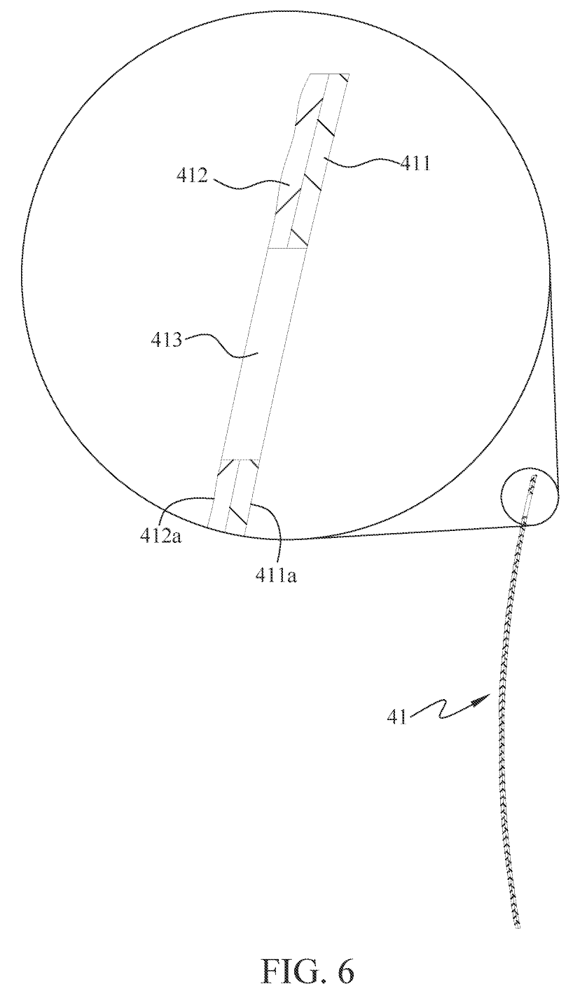

Referring to FIG. 6, the translucent flap 41 of the present invention includes a first thermoplastic plastic layer 411, a second thermoplastic plastic layer 412 in contact with the inner window portion 404, and an opening 413 penetrating the first thermoplastic plastic layer 411 and the second thermoplastic plastic layer 412. The first thermoplastic plastic layer 411 is a transparent sheet made of polyethylene terephthalate (PET), and the second thermoplastic plastic layer 412 is a translucent sheet made of thermoplastic polyurethane (TPU). The dimensions of the transparent sheet and the translucent sheet are respectively between 0.01 millimeters to 0.1 millimeters, so that the thickness of the translucent flap 41 does not exceed 0.2 millimeters.

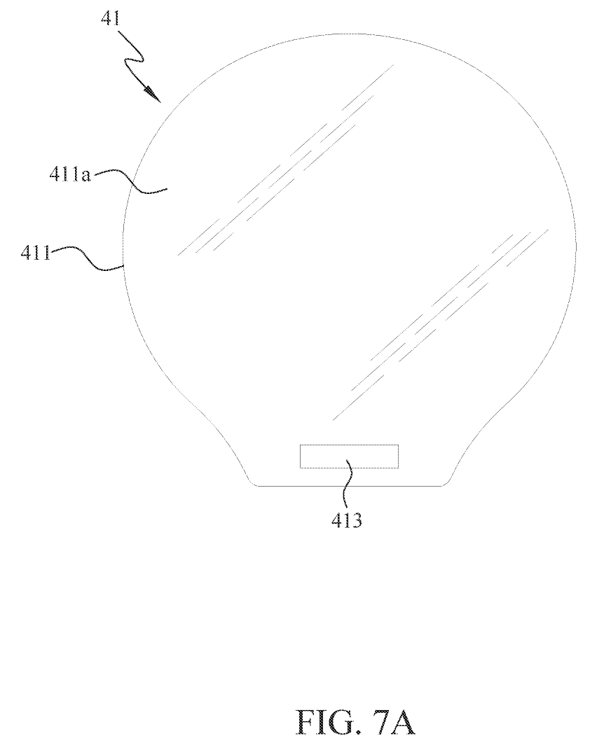

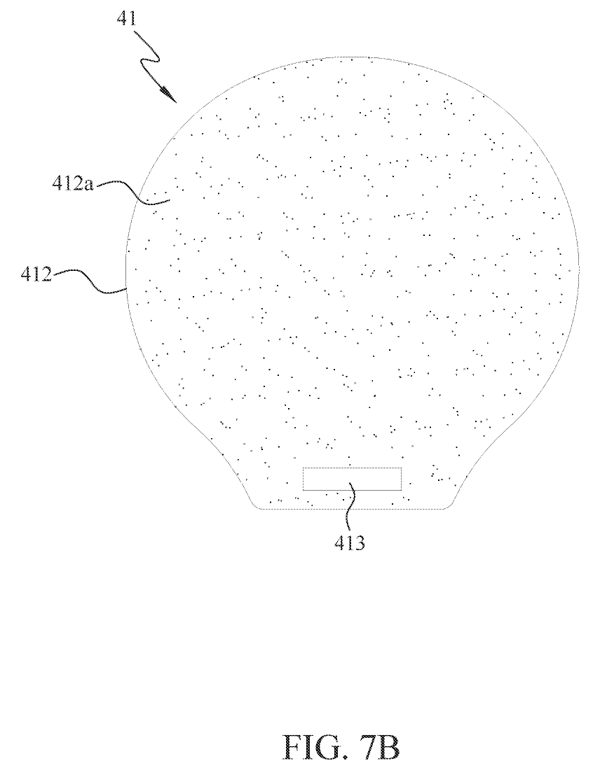

The first thermoplastic plastic layer 411 has a first surface roughness and a first elasticity, and the second thermoplastic plastic layer 412 has a second surface roughness greater than the first surface roughness and a second elasticity greater than the first elasticity. Referring to FIGS. 7A and 7B, the first thermoplastic plastic layer 411 has a transparent and colored smooth surface 411a, and the second thermoplastic plastic layer 412 has a translucent and colored matte surface 412b.

Referring to FIGS. 3 to 5 again, the valve cover 42 is detachably connected to the valve seat 40, so that an accommodating space is formed between the valve seat 40 and the valve cover 42. The valve cover 42 has a shielding portion 421, an outer window portion 422, and a buckle portion 423 located at the edges of both the shielding portion 421 and the outer window portion 422. The shielding portion 421 overlaps an upper half region of the inner window portion 404 and the fixing portion 405, and the outer window portion 422 overlaps a lower half region of the inner window portion 404. The buckle portion 423 is provided with a plurality of buckle bars 424 on an inner side surface that are matched and clamped against the inner concave annular groove 402. In addition, the shielding portion 421 has a pressing member 425 extending towards the translucent flap 41, so that a pressed end of the translucent flap 41 can be clamped and positioned by the pressing member 425 and the fixing portion 405.

As shown in the figure, the height of the valve cover 42 gradually increases from the shielding portion 421 towards a tail end of the outer window portion 422, so that the outer window portion 422 is formed with a plurality of three-dimensional ribs 426 and a plurality of three-dimensional windows 427 that are arranged alternately, where each three-dimensional rib 426 includes a claw portion 426a that rises along an arc path and an arm portion 426b connected between the claw portion 426a and the buckle portion 423, and each three-dimensional window 427 has a front opening 427a between two claw portions 426a and a side opening 427b located between two arm portions 426b.

Furthermore, the pressing member 425 has a sleeve 425a that matches the inserting plate, a lateral piece 425b spaced apart from the sleeve 425a, and a plurality of reinforcing ribs 425c located between the sleeve 425a and the lateral piece 425b; the width of the lateral piece 425b is greater than that of the sleeve 425a, and the lateral piece 425b overlaps the position of the inner window portion 404, and meanwhile the sleeve 425a, the plurality of reinforcing ribs 425c and the lateral piece 425b cooperate with the descent region A1 to present a arc-shaped pressing surface.

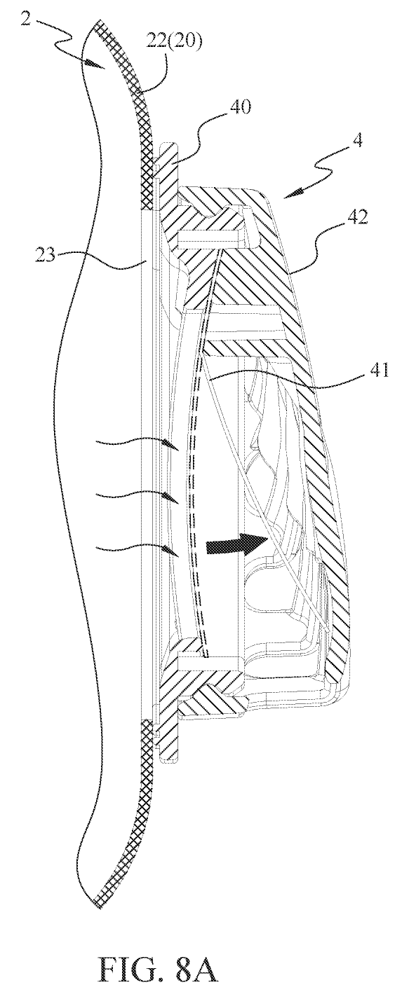

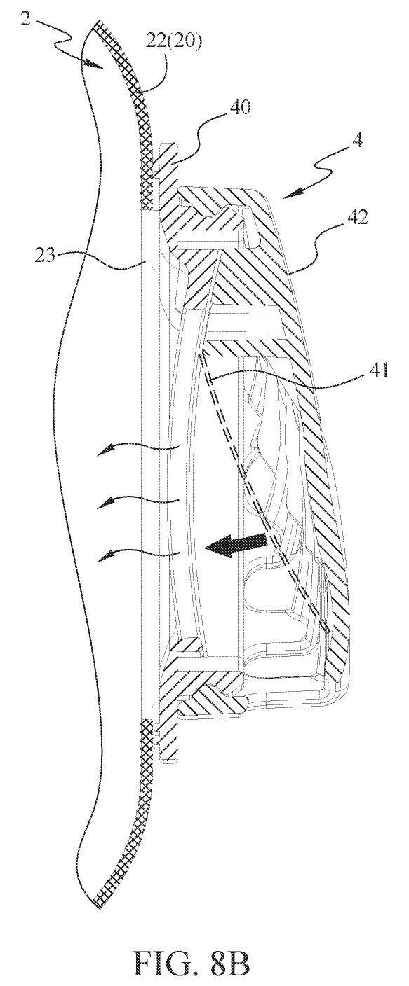

Referring to FIG. 8A, a partial region of the translucent flap 41 above the lateral piece 425b forms the pressed end, and a remaining region of the translucent flap 41 below the lateral piece 425b forms a free end that can be pushed by an airflow of breathing. When the user wearing the mask 1 of the present invention exhales, the translucent flap 41 will cooperate with the inner window portion 404 to change from the closed state to an open state.

Referring to FIG. 8B, on the contrary, when the user wearing the mask 1 of the present invention inhales, the translucent flap 41 will cooperate with the inner window portion 404 to change from the open state back to the closed state, and meanwhile, the external air will flow into the interior of the mask 1 through the three-dimensional filtering material 20.

What is claimed is:

1. A mask with a translucent flap, comprising:
a mask body for covering a mouth and a nose of a user, the mask body having an opening portion;
an elastic band being connected to the cover body; and
an air valve being connected to the opening portion, so that the opening portion forms a closed state, the air valve comprising:
a valve seat includes a surrounding wall portion forming a target profile, an inner window portion, and a fixing portion. The inner window portion and the fixing portion are connected at an inner side of the surrounding wall portion;
a translucent flap being assembled on the fixing portion to cover the inner window portion, and the translucent flap having a target shape matching the target profile; and
a valve cover detachably connected to the valve seat, and an accommodating space is formed between the valve seat and the valve cover, the valve cover has a shielding portion for overlapping an upper half region of the inner window portion and an outer window portion for overlapping a lower half region of the inner window portion, and the shielding portion extends a pressing member towards the translucent flap;
wherein a pressed end of the translucent flap being clamped by the pressing member and the fixing portion, and a free end of the translucent flap is capable of being pushed by a breathing airflow to change the closed state of the opening portion to an open state;
wherein the translucent flap comprises a first thermoplastic plastic layer and a second thermoplastic plastic layer in contact with the inner window portion, the first thermoplastic plastic layer has a first surface roughness and a first elasticity, the second thermoplastic plastic layer has a second surface roughness greater than the first surface roughness and a second elasticity greater than the first elasticity; and the first thermoplastic plastic is polyethylene terephthalate, and the second thermoplastic plastic is thermoplastic polyurethane.

2. The mask with a translucent flap according to claim 1, wherein the fixing portion of the valve seat extends towards the valve cover to form an inserting plate, and the pressing member of the valve cover includes a sleeve that matches the inserting plate, a lateral piece spaced apart from the sleeve, and a plurality of reinforcing ribs connected between the sleeve and the lateral piece.

3. The mask with a translucent flap according to claim 2, wherein the width of the lateral piece is greater than that of the sleeve, and the position of the lateral piece overlaps the inner window portion.

4. The mask with a translucent flap according to claim 3, wherein the inner window portion is formed with a descent region and an ascent region in sequence from the pressed end towards the free end, so that the inner window portion is configured to an arc-shaped structure; and the sleeve, the reinforcing ribs and the lateral piece are matched with the descent region to present an arc-shaped pressing surface.

5. The mask with a translucent flap according to claim 4, wherein a raised wall is formed on the peripheries of both the descent region and the ascent region, and a surrounding groove is formed between the inner window portion and the surrounding wall portion, so that the inner window portion is entirely located outside an opening cross section of the opening portion.

6. The mask with a translucent flap according to claim 1, wherein the translucent flap has a gradually expanding profile and a gradually narrowing profile in sequence from the pressed end towards the free end, so that the target shape of the translucent flap and the target profile of the valve seat are configured to a shell shape.

7. The mask with a translucent flap according to claim 1, wherein the first thermoplastic plastic layer has a transparent and colored smooth surface, and the second thermoplastic plastic layer has a translucent and colored matte surface.
